(19) United States
(12) Patent Application Publication
(10) Pub. No.: US 2015/0022559 A1
(43) Pub. Date: Jan. 22, 2015

(54) METHOD AND APPARATUS FOR DISPLAYING IMAGES IN PORTABLE TERMINAL

(71) Applicant: Samsung Electronics Co., Ltd., Suwon-si (KR)

(72) Inventor: Kyunghwa KIM, Seoul (KR)

(21) Appl. No.: 14/335,168

(22) Filed: Jul. 18, 2014

(30) Foreign Application Priority Data
Jul. 18, 2013 (KR) 10-2013-0084502

(51) Int. Cl. G06T 3/20; G06F 3/0485; H04N 13/04

(52) U.S. Cl. CPC G06T 3/20; H04N 13/0447; G06F 3/0485
USPC 345/684

(57) ABSTRACT

A method of displaying an image in a portable terminal is provided. The method includescontinuously generating continuously at least one image of a subject,calculating a central point of the at least one image, anddisplaying a spatial image providing a spatial sense of the subject by using the central point.

### CROSS-REFERENCE TO RELATED APPLICATION(S)

This application claims the benefit under 35 U.S.C. §119(a) of a Korean patent application filed on Jul. 18, 2013 in the Korean Intellectual Property Office and assigned Serial number 10-2013-0084502, the entire disclosure of which is incorporated by reference.

### TECHNICAL FIELD

The present disclosure relates to a method and an apparatus for displaying an image in a portable terminal. More particularly, the present disclosure relates to a method and an apparatus for displaying a plurality of images of a predetermined subject to allow a user to feel a spatial sense and displaying a moved image by interworking a user's gesture.

### BACKGROUND

An electronic device having a camera function, especially, a portable terminal has provided a function of three-dimensionally displaying an image.

For example, there is a panorama picture function. Panorama photography refers to a scheme of photographing a picture which is longer than a general picture in left, right, up and down directions, in order to photograph large landscapes in one picture. In general, a panorama picture is completed by attaching a plurality of pictures, which are obtained by partially photographing a subject in turn, to each other in a transverse or longitudinal direction.

The panorama picture, from among related-art displays of still pictures, is evaluated to most three-dimensionally provide an image. However, regardless of a distance between a position of a camera and a background, the panorama picture function stores a two-dimensional image which the camera captures at the time of photographing and the display also displays one two-dimensional image so that a spatial sense may not be sufficiently provided.

Furthermore, a related-art panorama function is limited to photographing a subject by rotating about the camera. That is, according to the prior art, when the camera photographs a subject by rotating about the subject, it is not easy to provide a three-dimensional image.

Therefore, there is a need for a method and an apparatus for providing an image in which a user can feel a spatial sense in an electronic device including a camera.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a three-dimensional (3D) and interactive display, which can display a plurality of images of a predetermined subject to allow a user to feel a spatial sense.

Another aspect of the present disclosure is to provide an intuitive image moving method to the user to move and display an image which is displayed to allow the user to feel the spatial sense by interworking a user's gesture.

In accordance with an aspect of the present disclosure, a method of displaying an image in a portable terminal is provided. The method includes continuously generating at least one image of a subject,calculating a central point of the at least one image, anddisplaying a spatial image providing a spatial sense of the subject by using the central point.

In accordance with another aspect of the present disclosure, a portable terminal for displaying an image is provided. The portable terminal includes a camera unit configured to continuously generateat least one image of a subject, and a controller configured to controlcalculation of a central point of the at least one image, and to control displaying of a spatial image providing a spatial sense of the subject by using the central point.

According to the present disclosure, a plurality of images of a predetermined subject is displayed to allow the user to feel a spatial sense so that a more 3D and interactive display can be provided. Furthermore, there is an effect in that a displayed image intuitively can be moved by being interworked with the user's gesture.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclsoure will be more apparent from the following description taken in conjunction with the accompanying drawings, in which:

FIGS. 1A, 1B, and 1C illustrate a case of photographing a distant landscape according to an embodiment of the present disclosure;

FIGS. 2A, 2B, and 2C illustrate a case in which a camera photographs a subject while moving and keeping the subject in the center according to an embodiment of the present disclosure;

FIG. 3 illustrates in detail a case in which a camera photographs a subject while moving and keeping the subject in the center according to an embodiment of the present disclosure;

FIGS. 4A, 4B, 4C, and 4D illustrate an example of a method of three-dimensionally displaying images continuously generated around a subject according to an embodiment of the present disclosure;

FIG. 5 is a block diagram illustrating an internal structure of an electronic device according to an embodiment of the present disclosure;

FIG. 6 is a flow chart illustrating a method of displaying a spatial image, and moving and displaying the spatial image in response to a user's gesture according to an embodiment of the present disclosure;

FIGS. 7A, 7B, 7C, 7D, 7E, and 7F illustrate an example of continuously generating a plurality of images of a subject according to an embodiment of the present disclosure;

FIGS. 8A, 8B, and 8C illustrate an example of extracting a key frame according to an embodiment of the present disclosure;

FIGS. 9A, 9B, 9C, and 9D illustrate an example of calculating a center point of an image according to an embodiment of the present disclosure;

FIGS. 10A, 10B, and 10C illustrate an example of configuring a user's gesture according to an embodiment of the present disclosure; and

FIGS. 11A, 11B, 11C, 11D, 11E, and 11F illustrate an example of moving and displaying an image in response to a gesture of a user's head movement according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, various embodiments of the present disclosure will be described in detail with reference to the accompanying drawings.

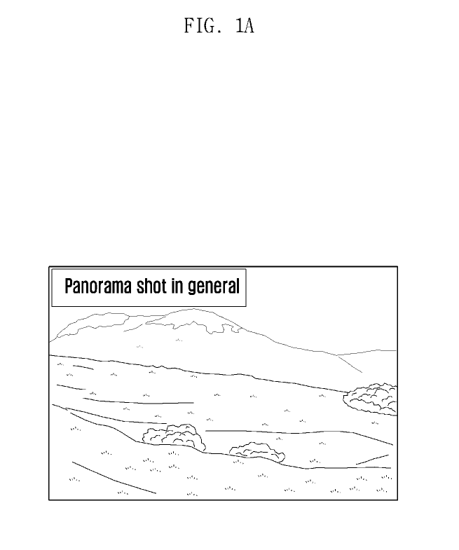

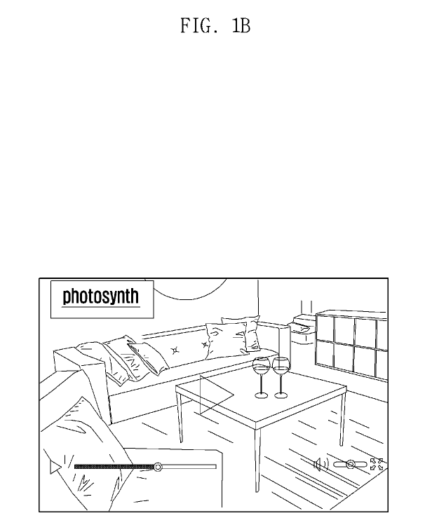

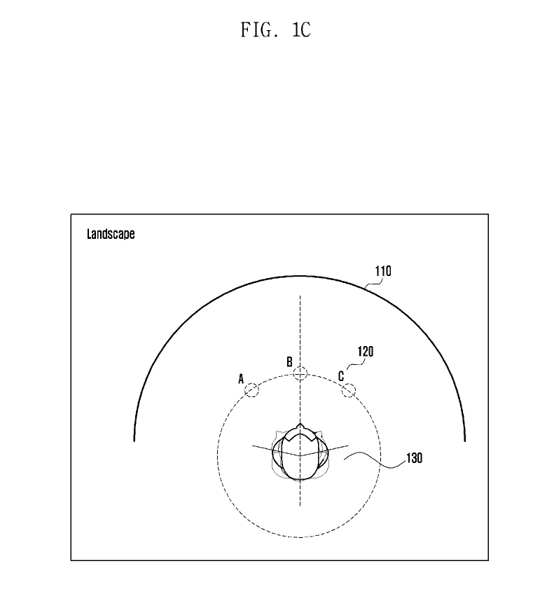

FIGS. 1A to 1C illustrates a case of photographing a distant landscape according to an embodiment of the present disclosure.

Referring to FIG. 1A, an example of a panorama picture is illustrated. In general, a panorama picture is generated by attaching a plurality of pictures, which are obtained by partially photographing a subject in turn, to each other in a transverse or longitudinal direction.

Referring to FIG. 1B,an example of a Photosynth, which refers to a technology of re-configuring pictures continuously generated in a same place by combining the pictures in a lump as a 3 Dimensional (3D) panorama video is illustrated.

FIGS. 1A and 1B are technologies for photographing a surrounding background of 360° around a photographer, and may be used to photograph landscapes and surroundings, as shown in FIG. 1C. That is, referring to FIGS. 1A, 1B and 1C, an image and/or a video generated by photographing a distant subject 110 while a user 130 rotates and moves a camera 120 of the maximum 360° is shown in FIG. 1C.

Embodiments illustrated in FIGS. 1A to 1C correspond to a technology for providing a 3D image, but a perspective sense may not be provided due to adopting a scheme for spreading images, which are captured by a camera, to be flat at the time of photographing regardless of a distance from a position of the camera to the background. Therefore, even though a wide space is photographed, there is a limitation of providing a vivid spatial sense at the time of the photographing.

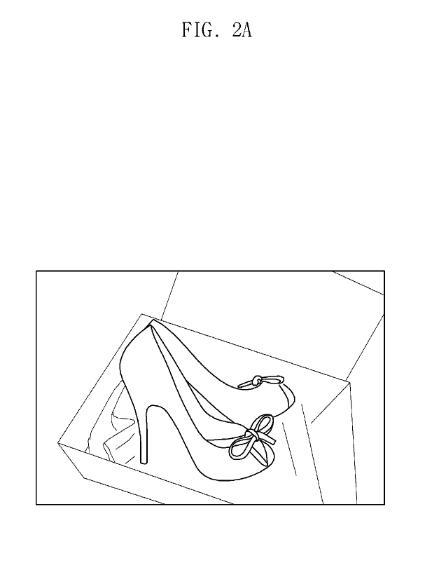

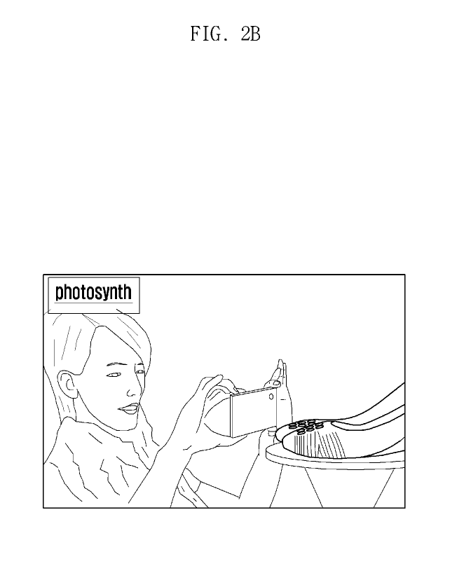

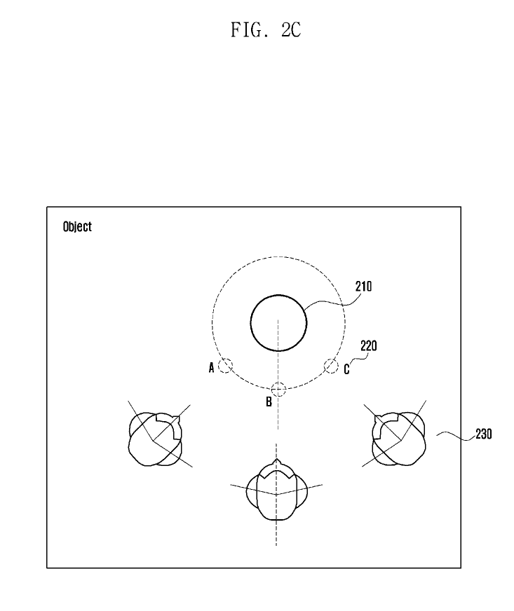

FIGS. 2A to 2C illustrate a case in which a camera photographs a subject while moving and keeping the subject in the center according to an embodiment of the present disclosure.

Referring to FIGS. 2A to 2C, when a photographer wants a 3D picture of shoes, as shown in FIG. 2A, the photographer photographs the shoes while rotating about the shoes, as shown in FIG. 2B. In this event, FIG. 2C illustrates a photograph structure. That is, while keeping a subject 210 in the center, a user 230 rotates together with a camera 220 to generate an image which may be used to generate image information by photographing a subject in a plurality of angles. However, in the related art, a method of three-dimensionally displaying the image generated while the camera rotates about the subject does not exist.

Therefore, embodiments of the present disclosure propose a method of displaying an image in a case where a photographer has collected the image by continuously photographing a subject while rotating about the subject at least one of leftwards, rightwards, upwards, and downwards, as in shooting a video.

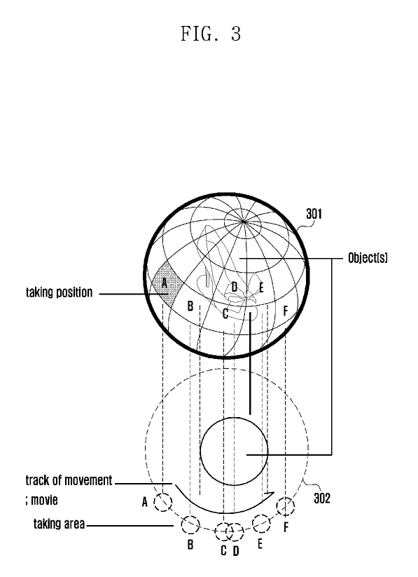

FIG. 3 illustrates a case in which a camera photographs a subject while moving and keeping the subject in the center according to an embodiment of the present disclosure.

Referring to FIG. 3, a sphere 301 is illustrated while providing a perspective sense around a subject, i.e., a shoe. A user can photograph the subject while turning at least one of leftwards, rightwards, upwards, and downwards by, at most, 360° around the subject.

A circle 302, illustrated in FIG. 3, provides a view in which the subject is seen from the top. For example, when the user photographs a 3D subject in an A->F direction, as shown in the sphere 301 of FIG. 3, a user's movement is illustrated by the circle 302 of FIG. 3. However, the present disclosure is not limited to a specific direction and/or order, such as A->F, and an order of the photographing does not matter.

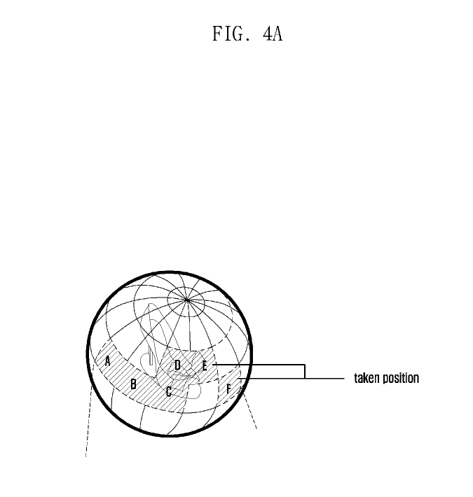

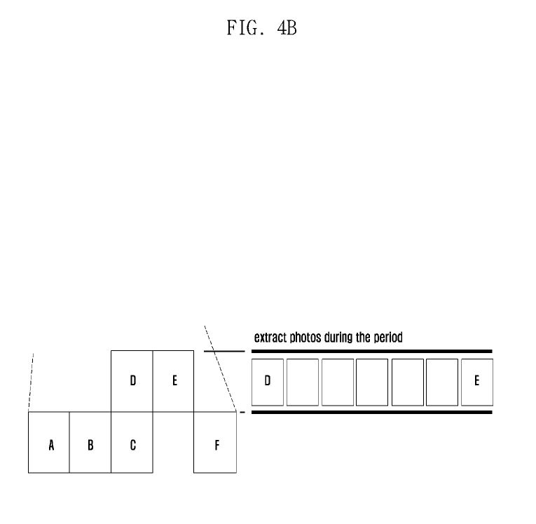

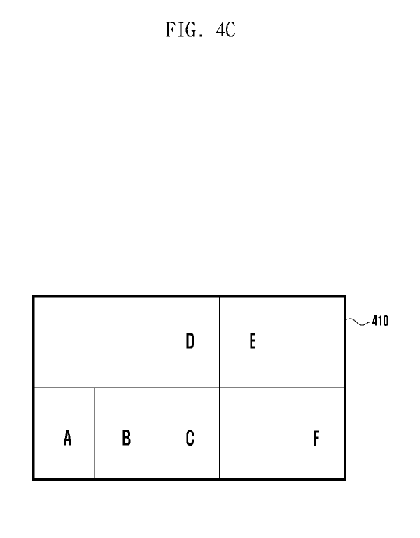

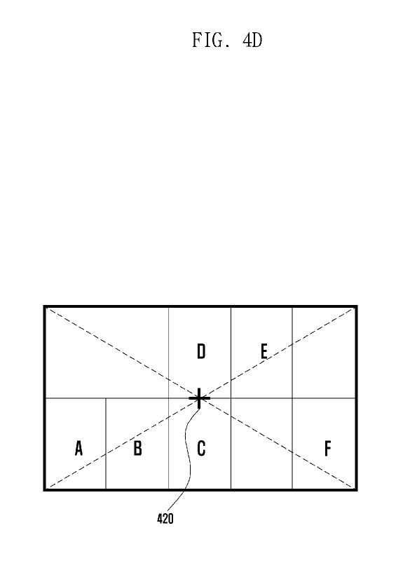

FIGS. 4A to 4D illustrate an example of a method of three-dimensionally displaying images continuously generated around a subject according to an embodiment of the present disclosure.

Referring to FIGS. 4A to 4D, an example of three-dimensionally displaying the extracted image according to an embodiment of the present disclosure is illustrated. For example, when the user takes a photograph in A-F positions, as shown in FIG. 4A, a portable terminal may analyze a movement from A to F by using a sensor. That is, a relative movement value is extracted using a sensor, such as an acceleration sensor, a gyro sensor, and the like, and an image is analyzed so that A-F relative locations can be calculated, as shown in FIG. 4B. An order of the photographing does not matter.

Then, the portable terminal may extract an area for a displacement movement of A-F. The portable terminal may generate a rectangle 410 minimally enclosing an area of A-F, as shown in FIG. 4C. This is for calculating a central point of a spatial image in which a spatial sense is provided. Hereinafter, the portable terminal may calculate a central point 420 using the rectangle 410 as shown in FIG. 4D.

A detailed description of each step will be discussed with accompanying drawings.

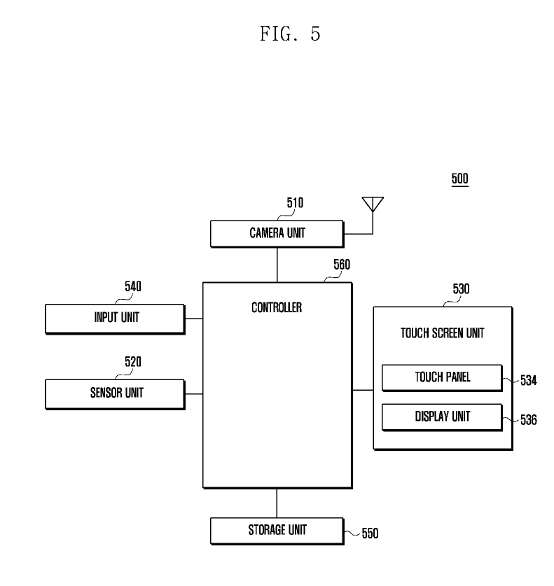

FIG. 5 is a block diagram illustrating an internal structure of an electronic device according to an embodiment of the present disclosure.

Referring to FIG. 5, an electronic device 500 according to an embodiment of the present disclosure may include a camera unit 510, a sensor unit 520, a touch screen unit 530, an input unit 540, a storage unit 550 and a controller 560.

The camera unit 510 may collect an image including at least one subject. The camera unit 510 may include an imaging unit (not shown) which converts an optical signal for a subject projected in a lens into an electrical signal, an image conversion unit (not shown) which processes a signal output from the imaging unit, converts the signal into a digital signal, and then converts the signal into a format suitable for processing in the controller 560, and a camera controller (not shown) which controls general operations of the camera unit 510.

The lens is configured with at least one lens and allows light proceed to the imaging unit after concentrating the light in order to collect an image. The imaging unit is configured as at least one of a Complementary Metal-Oxide Semiconductor (CMOS) imaging device, a Charge-Coupled Device (CCD) imaging device, or any other similar and/or suitable imaging device, and outputs a current and/or a voltage proportional to a brightness of the collected image so as to convert the image into the electrical signal. The imaging unit generates a signal of each pixel of the image and sequentially outputs the signal by synchronizing with a clock. The image conversion unit converts the signal output from the imaging unit into digital data.

The image conversion unit may include a codec which compresses the converted digital data into at least one of a Joint Photographic Experts Group (JPEG) format, a Moving Picture Experts Group (MPEG) format, or any other similar and/or suitable image and/or moving image format. In the image conversion, the converted digital data may be transmitted to the controller 560 and be used for an operation of the electronic device 500.

The sensor unit 520 may include at least one of an acceleration sensor, a gravity sensor, an optical sensor, a motion recognition sensor, a GBR sensor, and the like.

Especially, in the electronic device 500, according to an embodiment of the present disclosure, the sensor unit 520 may be used to extract a relative displacement value of an image obtained using the acceleration sensor, the gyro sensor, or the like.

The touch screen unit 530 includes a touch panel 534 and a display unit 536. The touch panel 534 senses a user's touch input. The touch panel 534 may be configured as a touch sensor, such as a capacitive overlay touch sensor, a resistive overlay touch sensor, an infrared beam sensing touch sensor, and the like, or may be formed of a pressure sensor or any other similar and/or suitable type of touch sensor. In addition to the sensors, all types of sensing devices that may sense a contact, a touch, or a pressure of an object may be used for configuring the touch panel 534.

The touch panel 534 senses the touch input of the user, generates a sensing signal, and then transmits the sensing signal to the controller 560. The sensing signal includes coordinate data associated with coordinates on which the user inputs a touch. When the user inputs a touch position movement operation, the touch panel 534 generates a sensing signal including coordinate data of a touch position moving path and then transmits the sensing signal to the controller 560.

The display unit 536 may be formed of a Liquid Crystal Display (LCD), an Organic Light Emitting Diode (OLED), an Active Matrix Organic Light Emitting Diode (AMOLED), and the like, and may visually provide a menu of the electronic device 500, input data, function setting information, and other information, to the user. Further, information for notifying the user of an operation state of the electronic device 500 may be displayed.

Even though the electronic device 500 of the present disclosure may include a touch screen, as described above, an embodiment of the present disclosure described below is not applied to only the electronic device 500 including a touch screen. When the present disclosure is applied to the portable terminal not including a touch screen, the touch screen unit 530, as shown in FIG. 5 may be applied so as to only perform a function of the display unit 536 and a function which the touch panel 534 performs, other than the function of the display unit 536, may be performed by the input unit 540 instead.

The input unit 540 receives a user's input for controlling the electronic device 500, generates an input signal, and then transmits the input signal to the controller 560. The input unit 540 may be configured as a key pad including a numeric key and a direction key, and may be formed with a predetermined function key on one side of the electronic device 500.

The storage unit 550 may store programs and data used for an operation of the electronic device 500, and may be divided into a program area (not shown) and a data area (not shown).

The program area may store a program which controls general operations of the electronic device 500 and may store a program provided by default in the electronic device 500, such as an Operating System (OS) which boots the electronic device 500, or the like. In addition, a program area of the storage unit 550 may store an application which is separately installed by the user, for example, a game application, a social network service execution application, or the like.

The data area is an area in which data generated according to use of the electronic device 500 is stored. The data area according to an embodiment of the present disclosure may be used to store a consecutive image of the subject.

The controller 560 controls general operations for each component of the electronic device 500. Particularly, in the electronic device 500 according to the embodiment of the present disclosure, the controller 560 extracts a key frame, calculates a central point, and then controls a series of processes of displaying an image in which the spatial sense is provided, using an image generated by the camera unit 510.

Furthermore, the controller 560 receives a signal from the touch panel 534, the sensor unit 520, or the camera unit 520 and recognizes a user's gesture so that a series of processes of moving and providing a displayed image according to the user's gesture can be also controlled.

A detailed example of displaying the spatial image in which the spatial sense is provided, and moving and providing the spatial image according to the user's gesture will be described with accompanying drawings.

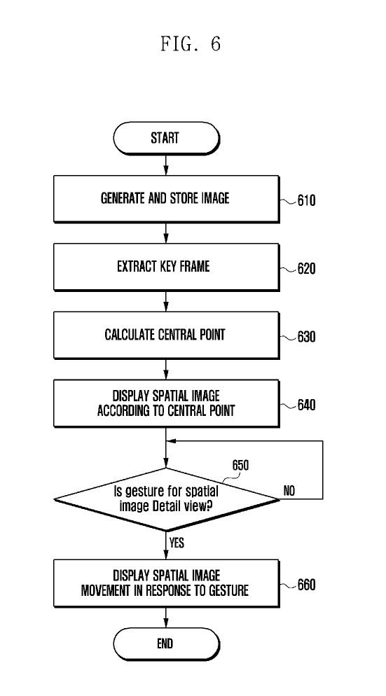

FIG. 6 is a flow chart illustrating a method of displaying a spatial image, and moving and displaying the spatial image in response to a user's gesture according to an embodiment of the present disclosure.

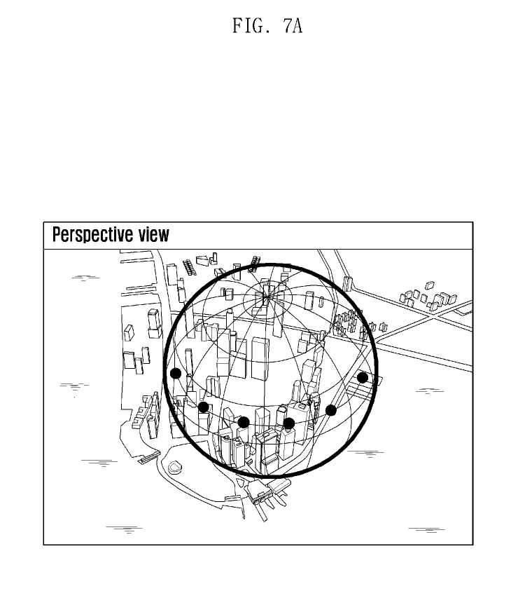

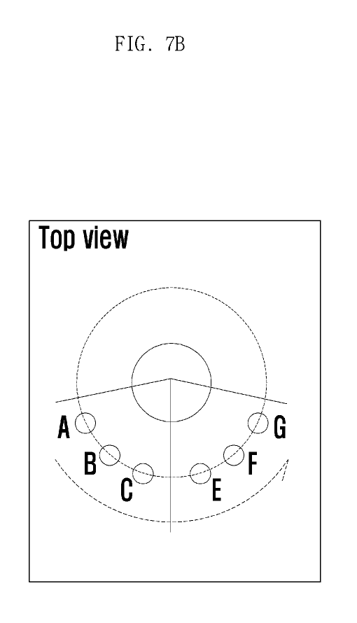

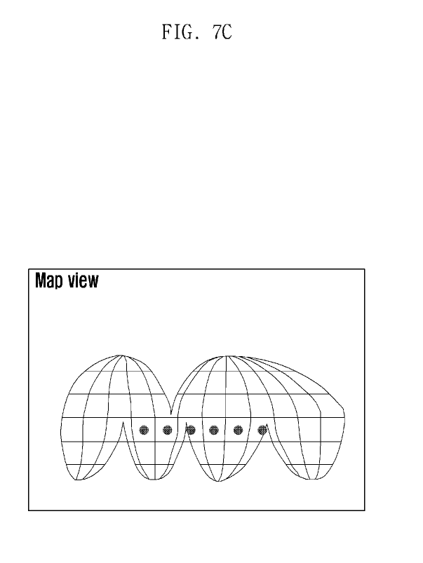

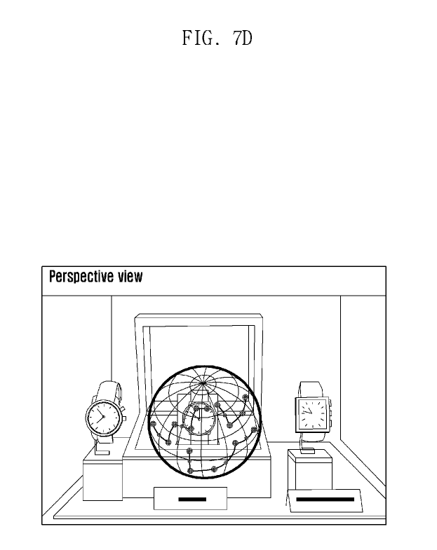

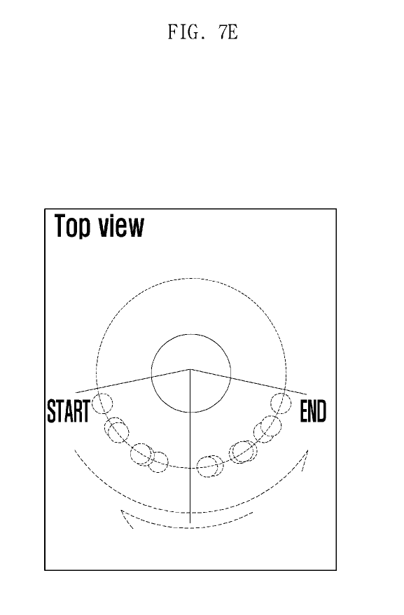

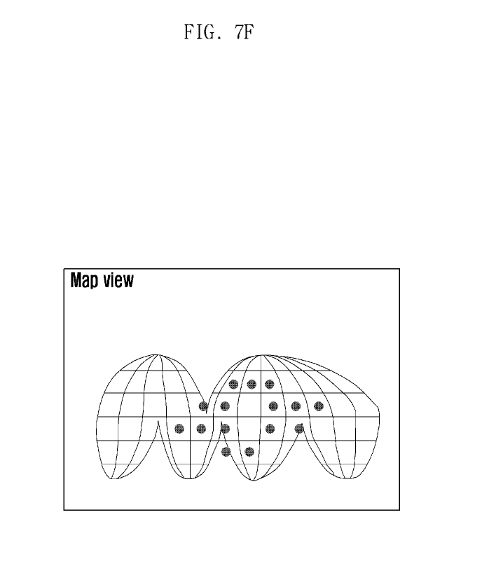

Referring to FIG. 6, in operation 610, the camera unit 510 continuously generates at least one image around the subject while changing latitudes and/or longitudes, the sensor unit 520 identifies a relative displacement value of each image, and the storage unit 550 may store the generated image and the displacement value. An example of operation 610 is illustrated in FIGS. 7A to 7F.

FIGS. 7A to 7F illustrate an example of continuously generating a plurality of images of a subject according to an embodiment of the present disclosure.

Referring to FIGS. 7A and 7D, both are cases in which the user photographs a subject by rotating about the subject to be photographed as in shooting a video.

FIG. 7A is an example of photographing the subject by keeping a longitudinal difference without a latitude variation, or in other words, an example of photographing the subject while having a longitudinal variance while not having a latitude variation. In this event, a photographing position is illustrated at a top view, as shown in FIG. 7B. Further, FIG. 7C illustrates that an obtained image is spread out.

Meanwhile, FIG. 7D illustrates an example in which latitude and longitude are changed together. In this event, a photographing position is illustrated at the top view, as shown in FIG. 7E. Further, FIG. 7F illustrates that an obtained image is spread out. The sensor unit 520 may be used to calculate a displacement value of the obtained image as shown in FIGS. 7C and 7F.

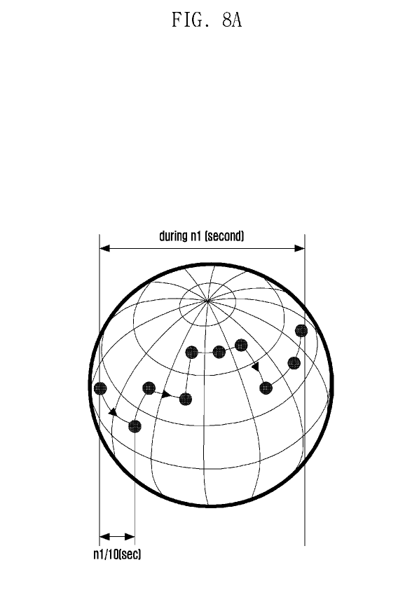

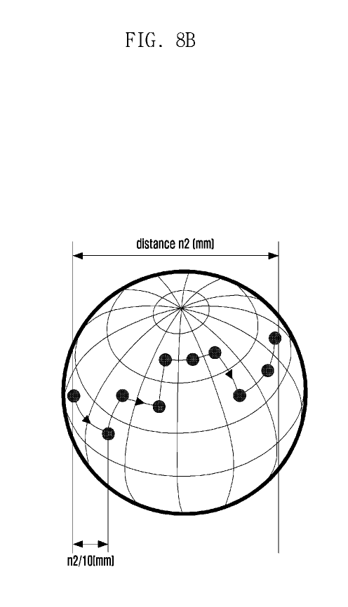

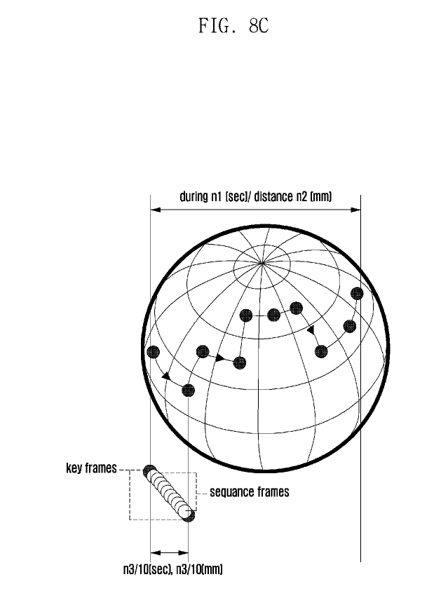

Returning to a description of FIG. 6, in operation 620, the controller 560 may extract a key frame for calculating a central point in the obtained image. An example of operation 620 is illustrated in FIGS. 8A to 8C.

FIGS. 8A to 8C illustrate an example of extracting a key frame according to an embodiment of the present disclosure.

In operation 610, the stored image is formed in a type which is similar to an animation video as a result of a plurality of images photographed during a predetermined time being continuously obtained. In order to extract a key frame of the plurality of images, according to an embodiment of the present disclosure, it is possible to consider a determination of reference points with a time interval between them and extraction using n 1/10 seconds(sec) per frame between the reference points, as shown in FIG. 8A. Meanwhile, it is possible to consider a method of extraction using n 2/10 millimeters (mm) per frame between the reference points, which are determined based on a distance interval between them, as shown in FIG. 8B.

FIGS. 8A and 8B illustrate only the reference point, but in practice, it is possible to extract an image using n 3/10 sec or n 3/10 mm between the reference points, as shown in FIG. 8C.

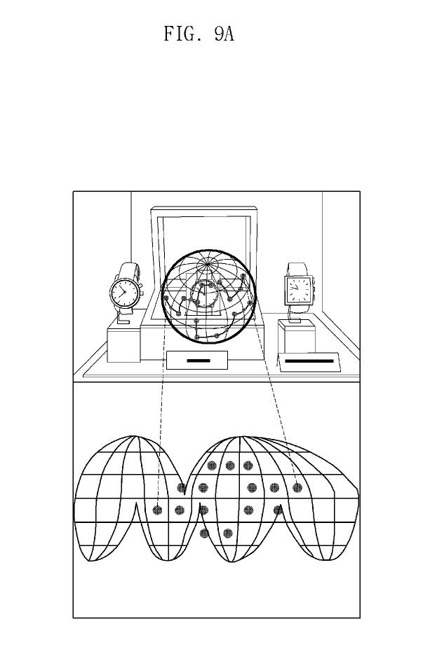

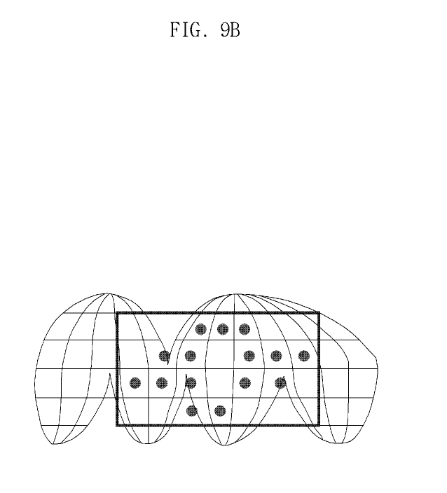

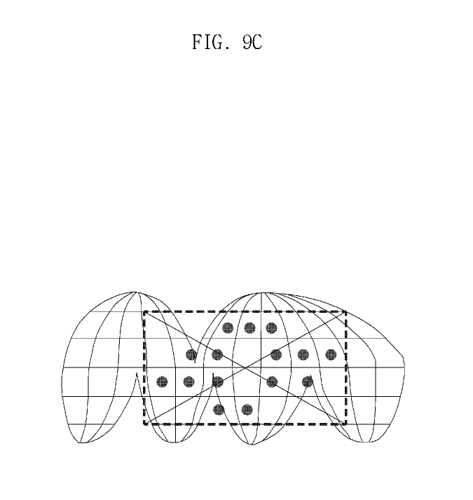

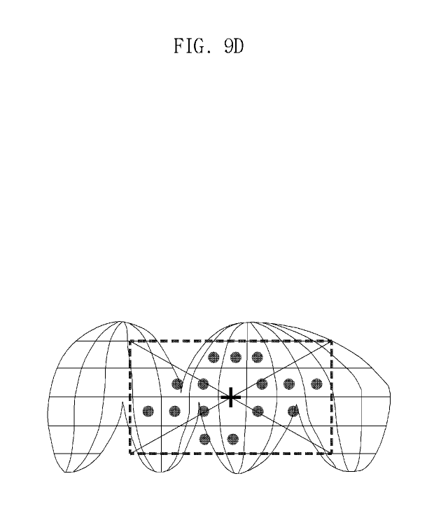

Returning to the description of FIG. 6, in operation 630, the controller 560 may calculate a central point using the key frame. An example of operation 630 is illustrated in FIG. 9.

FIGS. 9A, 9B, 9C, and 9D illustrate an example of calculating a center point of an image according to an embodiment of the present disclosure.

Referring to FIGS. 6 and 9A to 9D, in operation 620, when the extracted images are arranged, a plurality of still images may be formed by spreading out through a route which is identical to a pattern in which the camera moves at the time of photographing, as shown in FIG. 9A. Therefore, when an image is displayed to allow the user to feel a spatial sense in one display, a reference point is needed so as to display a spatial image around the reference point, and to move and display the spatial image at least one of upwards, downwards, leftwards, rightwards, forwards, and backwards in response to a user's gesture.

According to an embodiment of the present disclosure, a process of calculating the central point may be processed as shown in FIGS. 9B to 9D. That is, a minimum rectangle circumscribed by the key frame may be extracted, as shown in FIG. 9B, diagonal lines of the circumscribed rectangle may be drawn, as shown in FIG. 9C, and an intersection of the diagonal lines may be processed as a central point, as shown in FIG. 9D.

Referring to FIG. 6, in operation 640, the controller 560 may control the display unit 530 to display the spatial image according to, and/or by using, the central point.

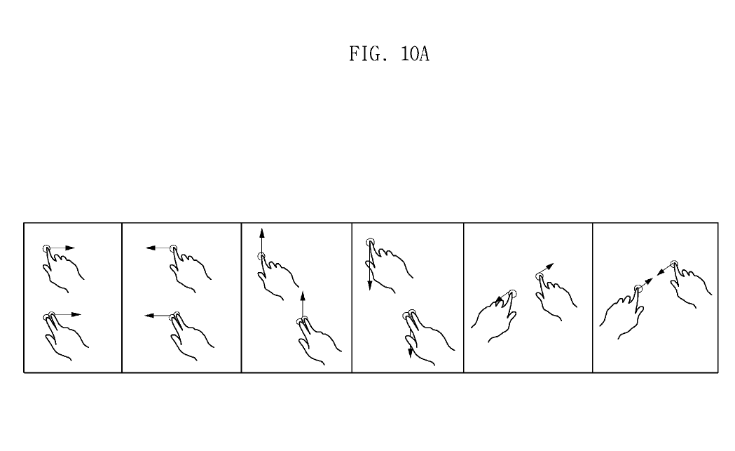

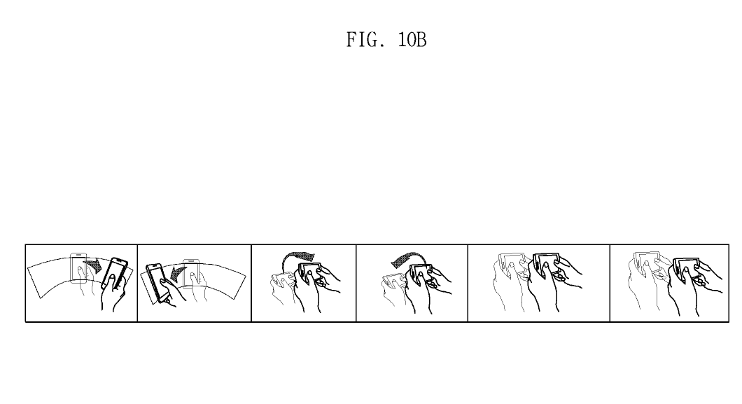

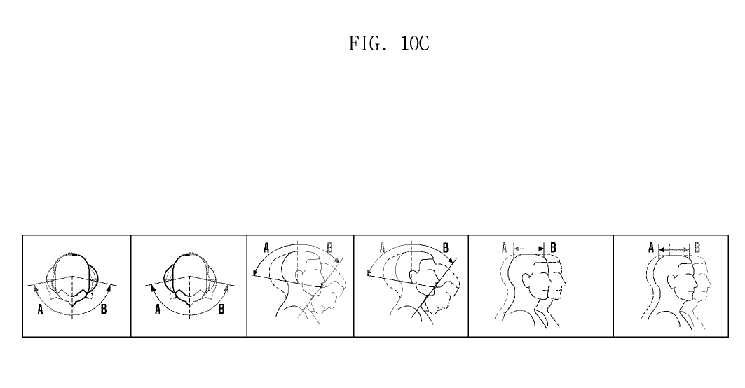

In operation 650, the controller 560 may determine whether a user's detail view gesture has been received through at least one of the sensor unit 520, the touch panel 534, the camera unit 510, or the like, and the controller 560 may move and display the spatial image by interworking with the user's gesture. FIGS. 10A to 10C illustrate an example of operation 650.

FIGS. 10A, 10B, and 10C illustrate an example of configuring a user's gesture according to an embodiment of the present disclosure.

Referring to FIG. 10A, an example of receiving a user's touch gesture through the touch panel 534 is illustrated. As shown in FIG. 10A, a drag input in a right direction may be configured as a gesture which moves a displayed image in a right direction. Further, a drag input in a left direction may be configured as a gesture which moves the displayed image in the left direction, a drag input in an upward direction may be configured as a gesture which moves the displayed image in the upward direction, and a drag input in a downward direction may be configured as a gesture which moves the displayed image in the downward direction.

Referring to FIG. 10A, according to an embodiment of the present disclosure, a double drag input, in a direction in which two contact points are away from each other, may be configured as a gesture which moves the displayed image forward, and a double drag input, in a direction in which two contact points approach each other, may be configured as a gesture which moves the displayed image backward. However, the present disclosure is not limited thereto, and any suitable user's touch gesture may correspond to any suitable movement of the displayed image.

Referring to FIG. 10B, an example of receiving a user's motion gesture through the sensor unit 520 is illustrated. As shown in FIG. 10B, an input of tilting the terminal in a right direction may be configured as a gesture which moves a displayed image in the right direction. In addition, an input of tilting the terminal in a left direction may be configured as a gesture which moves the displayed image in the left direction, an input of tilting the terminal in an upward direction may be configured as a gesture which moves the displayed image in the upward direction, and an input of tilting the terminal in a downward direction may be configured as a gesture which moves the displayed image in the downward direction.

Referring to FIG. 10B, according to the embodiment of the present disclosure, an input of bringing the terminal close to the user may be configured as a gesture which moves the displayed image forward, and an input of pushing the terminal in the opposite direction to away from the user may be configured as a gesture which moves the displayed image backward.

Meanwhile, FIG. 10C illustrates an example of receiving a user's head movement gesture through the sensor unit 520 and the camera unit 150. As shown in FIG. 10C, an input of tilting the head in a right direction may be configured as a gesture which moves a displayed image in the right direction. In addition, an input of tilting the head in a left direction may be configured as a gesture which moves the displayed image in the left direction, an input of tilting the head backward may be configured as a gesture which moves the displayed image in an upward direction, and an input of tilting the head forward may be configured as a gesture which moves the displayed image in a downward direction.

Referring to FIG. 10C, according to the embodiment of the present disclosure, an input of moving the head forward may be configured as a gesture which moves the displayed image forward and an input of moving the head backward may be configured as a gesture which moves the displayed image backward.

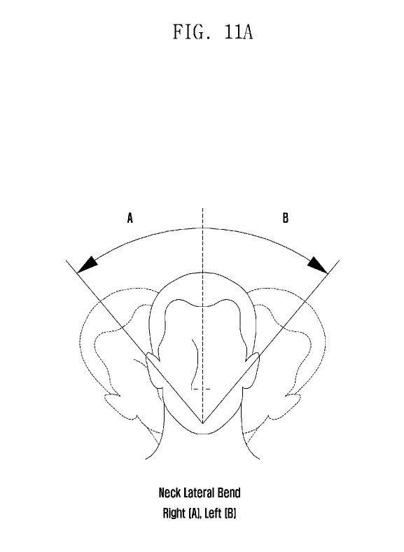

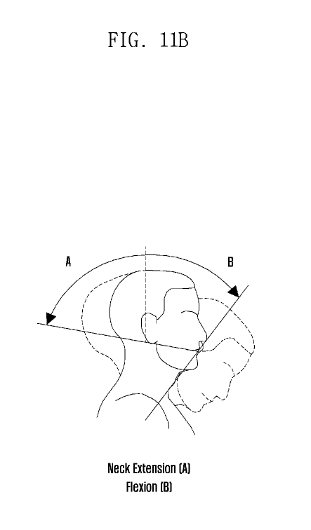

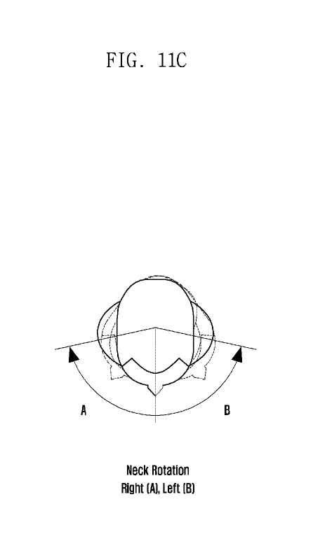

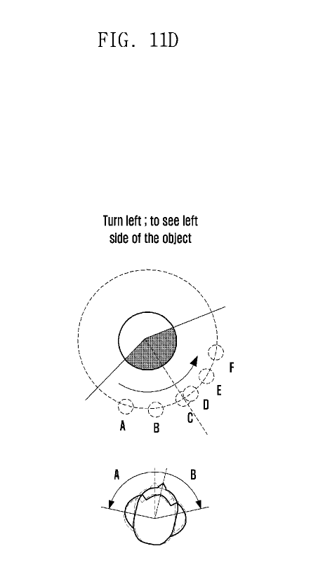

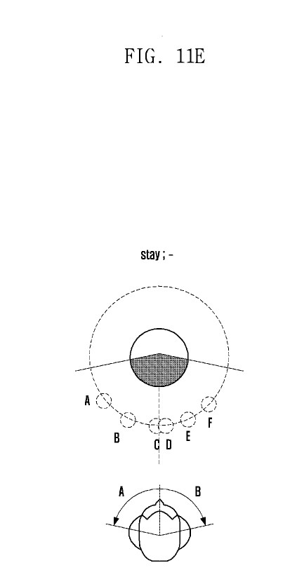

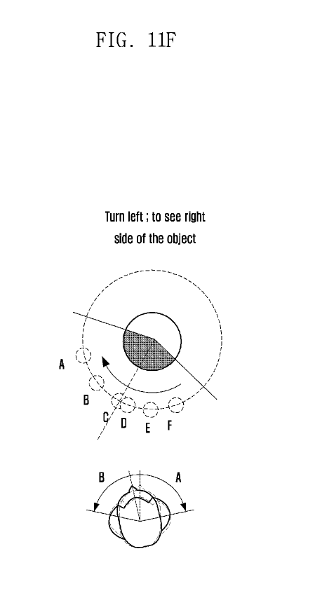

Referring to FIG. 6, in operation 660, the controller 560 may control the display unit 530 to display spatial image movement in response to a user's gesture. FIGS. 11A to 11E illustrate an example of operation 660 in FIG. 6 according to an embodiment of the present disclosure.

FIGS. 11A to 11E illustrate an example of moving and displaying an image in response to a gesture of a user's head movement according to an embodiment of the present disclosure.

Referring to FIGS. 11A to 11E, a user's head movement may be considered an operation of tilting a head in a left or right direction, with reference to a front of a face, as shown in FIG. 11A, an operation of tilting the head forward or backward, with respect to a side of the face, as shown in FIG. 11B, and an operation of rotating a neck in a left and right direction, with respect to the top of the head, as shown in FIG. 11C.

FIGS. 11D to 11F illustrate an example of configuring the user's head movement as a spatial image movement gesture. For example, in a case of the operation of rotating the head leftward and rightward, with respect to the top of the head, when the head rotates leftward, as shown in FIGS. 11D, the spatial image may move leftward and be displayed. Further, when the head does not move, the spatial image may be displayed as it is, as shown in FIG. 11E. When the head rotates rightward, the spatial image may move rightward and be displayed, as shown in FIG. 11F.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of displaying an image in a portable terminal, the method comprising:
continuously generating at least one image of a subject;
calculating a central point of the at least one image; and
displaying a spatial image providing a spatial sense of the subject by using the central point.

2. The method of claim 1, further comprising moving and displaying the spatial image in response to a user's gesture.

3. The method of claim 2, wherein the continuously generating of the at least one image comprises determining a movement route in which the at least one image is generated by using an inertial sensor.

4. The method of claim 3, wherein the calculating of the central point comprises:
extracting at least one key frame based on at least one of a time and a position in which the images are generated; and
calculating the central point using the at least one key frame.

5. The method of claim 4, wherein the extracting of the at least one key frame comprises:
dividing a whole time in which the images are generated into a predetermined number; and
extracting images corresponding to the divided time with the key frame.

6. The method of claim 4, wherein the extracting of the key frame comprises:
dividing a whole distance in which the images are generated into a predetermined number; and
extracting images corresponding to the divided distance with the key frame.

7. The method of claim 4, wherein the calculating of the central point comprises:
extracting a minimum rectangle including all of the at least one key frame; and
calculating a point where diagonal lines of the minimum rectangle intersect as the central point.

8. The method of claim 2, wherein the moving and the displaying of the spatial image comprises:
determining a movement of a user's head with respect to the spatial image to be at least one of an upward movement, a downward movement, a leftwardmovement, a rightwardmovement, a forward movement, and a backwardmovement; and
moving and displaying the spatial image according to the movement of the user's head.

9. The method of claim 2, wherein the moving and the displaying of the spatial image comprises:
determining a movement of a portable terminal, in a state in which the spatial image is displayed, to be at least one of an upward movement, a downward movement, a leftward movement, a rightward movement, a forward movement, and a backward movement; and
moving and displaying the spatial image according to the movement of the portable terminal

10. A portable terminal for displaying an image, the portable terminal comprising:
a camera unit configured to continuously generateat least one image of a subject; and
a controller configured to controlcalculation of a central point of the at least one image, and to control displaying of a spatial image providing a spatial sense of the subject by using the central point.

11. The portable terminal of claim 10, wherein the controller is configured to control movement and displaying of the spatial image in response to a user's gesture.

12. The portable terminal of claim 11, wherein the controller is configured to control determining of a movement route in which the images are generated by using an inertial sensor.

13. The portable terminal of claim 12, wherein the controller is configured to controlextracting of at least one key frame based on at least one of a time and a position in which the images are generated, and
wherein the controller is configured to control calculating of the central point using the key frame.

14. The portable terminal of claim 13, wherein the controller is configured to controldividing of a whole time in which the images are generated into a predetermined number, and
wherein the controller is configured to control extracting of images corresponding to the divided time with the key frame.

15. The portable terminal of claim 13, wherein the controller is configured to controldividing of a whole distance in which the images are generated into a predetermined number, and
wherein the controller is configured to control extracting of images corresponding to the divided distance with the key frame.

16. The portable terminal of claim 13, wherein the controller is configured to control extracting of a minimum rectangle including all the key frames, and
wherein the controller is configured to control calculating of a point where diagonal lines of the minimum rectangle intersect as the central point.

17. The portable terminal of claim 16, wherein the controller is configured to control determining of a movement of a user's head with respect to the spatial image to be at least one of an upward movement, a downward movement, a leftward movement, a rightward movement, a forward movement, and a backward movement of a user's head with respect to the spatial image, and
wherein the controller is configured to control movement and displaying of the spatial image according to the movement of the user's head.

18. The portable terminal of claim 17, wherein the controller is configured to control determining a movement of a portable terminal, in a state in which the spatial image is displayed, to be at least one of an upward movement, a downward movement, a leftward movement, a rightward movement, a forward movement, and a backward movement, and
wherein the controller is configured to control movement and displaying of the spatial image according to the movement of the portable terminal.

19. The portable terminal of claim 10, further comprising a touch screen unit configured to display the spatial image according to the control of the controller.
